(19) United States
(12) Patent Application Publication
(10) Pub. No.: US 2007/0184960 A1
(43) Pub. Date: Aug. 9, 2007

(54) TEAR TAPE APPLICATOR FOR REAM WRAP AND OTHER PACKAGING MATERIALS

(76) Inventors: Michael R. Nowak, Hilbert, WI (US); David W. Schneider, Elkhart Lake, WI (US)

Correspondence Address: WEISS & WEISS, Suite 251, 300 Old Country Road, Mineola, NY, 11501, US

(21) Appl. No.: 11/691,158

(22) Filed: Mar. 26, 2007

Related U.S. Application Data
(62) Division of application No. 11/077,683, filed on Mar. 11, 2005, now abandoned.
Application No. 11/077,683 is a continuation-in-part of application No. 10/797,312, filed on Mar. 10, 2004.

(51) Int. Cl. B31B 1/90

(52) U.S. Cl. 493/377

(57) ABSTRACT

A method and equipment for applying tear tape to ream wrap, packaging material, and/or other paper or film products are disclosed. The method includes pulling a web of ream wrap or other packaging material through a number of festoon or dancer rolls that move up and down; momentarily stopping said ream wrap or other packaging material while wind-up and unwind roll speeds remain constant; and cutting and applying a strip of tear tape across said web of ream wrap or other packaging material while said web is momentarily stopped. The equipment is attached to rewinding and/or packaging equipment.

### CROSS-REFERENCE TO RELATED APPLICATIONS

This application is a divisional of U.S. Ser. No. 11/077,683, filed Mar. 11, 2005, which is a continuation-in-part of U.S. Ser. No. 10/797,312, filed Mar. 10, 2004.

### FIELD OF THE INVENTION

The present invention relates to equipment for applying tear tape to ream wrap and/or other paper or film products or packaging materials. The invention relates to equipment that is attached to rewinding and/or packaging equipment.

### BACKGROUND OF THE INVENTION

Wrapper for reams (i.e., 500 sheets) of cut paper is typically manufactured in large rolls, printed or not printed, and rewound and/or cut to specific sizes. The wrapper is then sold to paper manufacturers who package the reams of paper on wrapping lines. Reams of cut paper (8½×11, etc.) for copy machines, computers, printers, and other home and office applications are most commonly packaged for shipping, storage and retail sale in ream wrap made of various materials, including paper, paper/film combinations, and solid plastic films. As more people have acquired home computers and printers, the use of copier, printer, and computer papers by individual consumers has increased. Individual consumers typically purchase individually wrapped reams of paper at an office supply store, retail store, or through an office supply catalog.

Small business and home office users often need to use only part of a ream at a time and store the remainder of an open ream. A major disadvantage of traditional ream wrap packaging for the individual user is that the current method of opening the packaging destroys the integrity of the entire wrapped ream. For instance, when the folded bottom or top end of the wrapped ream is torn open, the entire folded package opens, destroying the integrity of the wrapped structure and exposing and scattering the loose sheets of paper remaining in the ream. For the individual user who uses only a portion of the ream at a time and needs to store the remaining sheets, the unbound papers pose an inconvenience and impediment to storage. Since the structural support of the original packaging is compromised, the result for individual users is often physical damage to the unbound sheets of paper being stored for future use.

The current marketplace demands a ream wrapper that may be opened so that a user may remove part of a ream and store the remaining sheets in a structure that prevents physical damage and scattering of loose papers. When torn, the tape enables one end of the package to open, leaving the remaining structure of the ream wrap intact. The remaining package enables the individual user to both safely and easily store and dispense papers.

### SUMMARY OF THE INVENTION

The present invention relates to a tear tape applicator unit for applying tear tapes to ream wraps or other packaging materials comprising: a number of festoon or dancer rolls that move up and down, pulling a web of ream wrap or other packaging material. The applicator cuts and applies a strip of tear tape across the web of a ream wrap or other packaging material. It is an object of the present invention for the ream wrap or other packaging material to momentarily stop while wind-up and unwind roll speeds remain constant. When the web is momentarily stopped, the applicator cuts and applies a strip of tear tape across the web of ream wrap or other packaging material.

It is an object of the present invention for the applicator to be attached to either wind-up or unwind end of a rewinding line.

It is an object of the present invention for the tear tape to be treated with self-adhesive material on one side and, when the web is stopped, a bar or other apparatus is used to push the web into the tear tape. The tear tape adheres to the web and at the same time a cutting plate or knife cuts the tear tape to match the width of the web.

It is an object of the present invention for the tear tape, which has been coated with wax, to be pushed into the web and cut to match the width of the web. It is an object of the present invention for the wax to adhere the tear tape to the web by either application of pressure or slight thermal energy.

It is an object for the present invention for the tear tape, which is comprised of polymer film or paper/polymer film combination to be subjected to heat or thermal energy, which makes the polymer tacky, allowing the tear tape to adhere to the ream wrap or other packaging material at the moment of cutting and when pressure is applied to contact the web and the tear tape.

It is an object of the present invention for the tear tape to be pulled out of a spindle unit above or below the web, which is connected to a motor that drives a belt across the web at the moment the web is stopped.

It is an object of the present invention for the applicator unit to pull one repeat at a time, cut and apply the tear tape and then pull in another repeat.

It is an object of the present invention for the applicator to be applied in front of a nip that pulls the web into a cutter unit which cuts the tear tape at the moment the tear tape is applied to the web.

It is an object of the present invention for the tear tape to be between about 1/32 and ½ inch in width. It is an object of the present invention for the applicator to apply more than one tear tape in one application.

The present invention relates to a method of attaching tear tape to ream wrap or other packaging materials comprising: pulling a web of ream wrap or other packaging material through a number of festoon or dancer rolls that move up and down, momentarily stopping the ream wrap or other packaging material while wind-up and unwind roll speeds remain constant; and cutting and applying a strip of tear tape across the web of ream wrap or other packaging material while the web is momentarily stopped.

It is an object of the present invention to treat the tear tape with self-adhesive material on one side and, when the web is stopped, push the web with a bar or other apparatus into the tear tape. The web is adhered to the tear tape and at the same time the tear tape is cut to match the width of the web with a cutting plate or knife.

It is an object of the present invention to coat the tear tape with wax, cut the tear tape to match the width of the web; and push the web in contact with the tear tape. It is an object of the present invention to adhere the tear tape to the web by either application of pressure or slight thermal energy.

It is an object of the present invention to apply heat to the tear tape, which is comprised of polymer film or paper/polymer film combination; making the polymer tacky, and adhering the tear tape to the ream wrap or other packaging material at the moment of cutting and when pressure is applied to contact the web and the tear tape.

It is an object of the present invention for the tear tape to be pulled out of a spindle unit above or below the web, which is connected to a motor that drives a belt across the web at the moment the web is stopped. It is an object of the present invention to apply more than one tear tape in one application.

The present invention relates to an applicator that applies tear tapes to the ream wrap or other packaging material during the rewinding process used by the manufacturer. It is an object of the present invention to attach an applicator unit to either end of a rewinder. It is an object of the present invention to apply the tear tape across the web of the ream wrap or other packaging material by momentarily stopping the web during the rewinding process. It is an object of the present invention to apply one or more tear tapes at a time, including but not limited to up to ten tear tapes in one application. The amount and spacing of the tear tapes may vary according to the repeated print design, finished length of the ream wrap or other packaging material, or other demands specific to packaging. It is an object of the present invention to vary the distances and number of applications of tear tape at one time during the rewinding process. It is a further object of the present invention to apply the tear tape across the web of the ream wrap or other packaging material on either the top or under side of the wrapper.

It is a further object of the present invention for the applicator unit to comprise a separate unit that stands alone, is removable, and may be fitted for and attached to a manufacturer's rewinding and/or wrapping equipment. In this way, the manufacturer can apply tear tapes on the web of ream wrap or other packaging material in its own rewinding and/or packaging processes. It is an object of the present invention to apply tear tapes to any type of ream wrapper or packaging, including paper, coated paper, solid plastic film, shrink wrap film, and paper/film combinations.

The present invention relates to equipment comprising a unit that applies tear tapes to ream wrap or other packaging material during the rewinding and/or packaging process. It is an object of the present invention for the unit to be attached to the manufacturer's rewinding equipment. It is an object of the present invention for a small individual unit to be attached to the manufacturer's rewinding and/or packaging equipment.

The equipment comprises a unit that drives across the web and cuts and applies tear tape to match the width of the ream wrapper or other packaging material. The equipment further comprises a unit that cuts and applies the tear tape at approximately 1 to 10 places while momentarily stopping the web through dancer rolls or festoon rolls. During all this, the unwind/wind-up speed of the rewinder remains constant. The equipment further comprises a unit that is adjustable in relationship to the first cutting and application point so that the tear tapes can be applied according to the size of the ream wrap or other packaging material, the distance of the printed or graphic repeat of the wrapper, or other specific packaging needs.

The present invention relates to a ream wrapper that is opened so that a user may remove part of a ream and store the remaining sheets in a structure that prevents physical damage and scattering of loose parts. It is an object of the present invention for the ream wrap to be opened by at least one tear tape.

The present invention relates to a ream wrapper comprising; a ream wrap that has one or more tear tapes inserted in the ream wrap across the web so that it surrounds the entire width of a wrapped ream. It is an object of the present invention for the tear tape to comprise a strip of paper or film that is drawn through or coated with wax. It is an object of the present invention for the tear tape to be 1/32″ to 1½″. It is an object of the present invention for the tear tape to be torn lengthwise, not across the width of the tear tape.

It is an object of the present invention for the tear tape to comprise a non-coated strip of paper or film that is heat-sealed onto the ream wrap. It is an object of the present invention for the tear tape to comprise a strip of high strength polymer film, such as polyethylene or polypropylene, with adhesive on one side of the strip. It is an object of the present invention for the tear tape to comprise identical material from which the ream wrap itself is made. It is an object of the present invention for the ream wrap and the tear tape to both be made of shrink wrap.

It is an object of the present invention for the tear tape to be attached by an adhesive. It is an object of the present invention for the ream wrap or other packaging material to have a tear tape on top of the ream wrap or other packaging material which opens the top of the ream wrap or other packaging material but keeps the integrity of the ream wrap or other packaging material. It is an object of the present invention for the ream wrap or other packaging material to have a tear tape that does not completely remove a section of the ream wrap or other packaging material.

It is a further object of the present invention for the tear tape to be inserted in the ream wrap across the web so that it surrounds the entire width of the wrapped ream. When pulled, the tear tape opens one portion of the top or bottom end of the package. When pulled, the tear tape opens and enables the removal of one of the sealed ends of the ream wrap while leaving, the remaining structure intact for storage and dispensing partial reams.

The present invention also relates to packaging materials that are used to wrap products, such as paper towels, napkins, toilet paper, or other consumer products, that have a tear tape applied across the web either on the packaging line or during the manufacturing of the packaging materials.

The present invention relates to equipment for applying tear tape to packaging which when directly open allows a user to use a product contained within the packaging.

### BRIEF DESCRIPTION OF THE DRAWINGS

FIG. 1 is a front view showing the equipment for applying tear tape to ream wrap and/or other paper or film products.

FIG. 2 is a top view of a system for applying tear tape.

FIG. 3 is a side view of a system for applying tear tape.

FIG. 4 is a top view of a system for applying tear tape.

FIG. 5 is a cross-sectional view of FIG. 4.

### DETAILED DESCRIPTION OF THE INVENTION

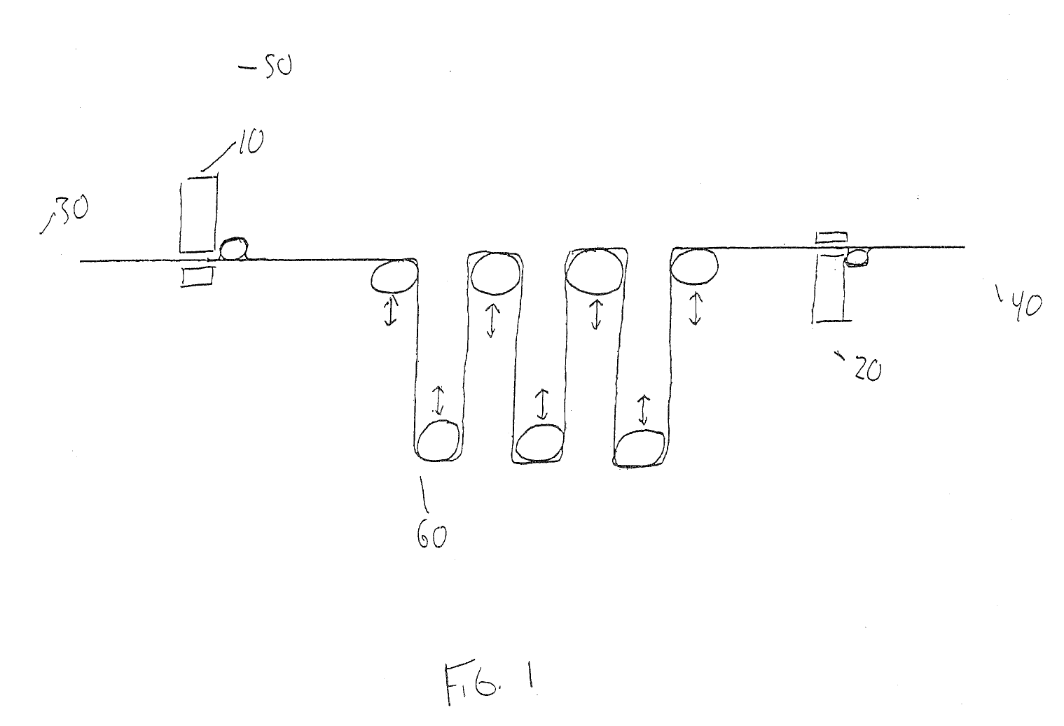

In one embodiment of the present invention, shown in FIG. 1, a tear tape applicator unit 10 and 20 is attached to either the wind-up 30 or unwind end 40 of a rewinding line 50. The applicator comprises, in part, a number of festoon or dancer rolls 60 that move up and down, pulling the web of ream wrap or other packaging material and momentarily stopping it while the wind-up and unwind roll speeds remain constant. When the web is momentarily stopped, the applicator then cuts and applies a strip of tear tape at 1 to 10 places across the web of the ream wrap or other packaging material.

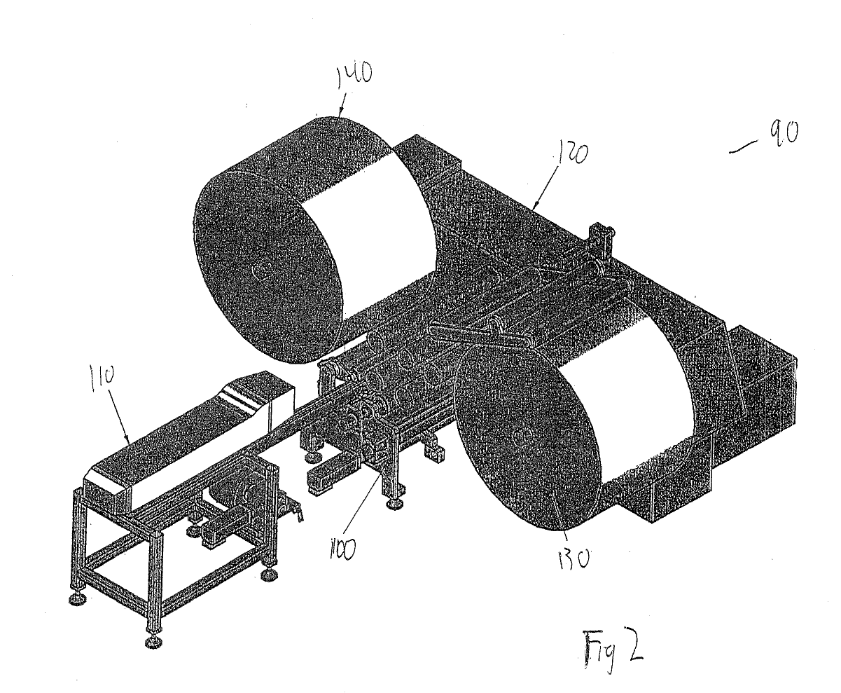

FIG. 2 shows a system 90 for applying tear tape comprising a tear tape applicator assembly 100, a laser/tear tape unwind assembly 110, Stanford winder 120, a rewind roll 130 and an unwind roll 140.

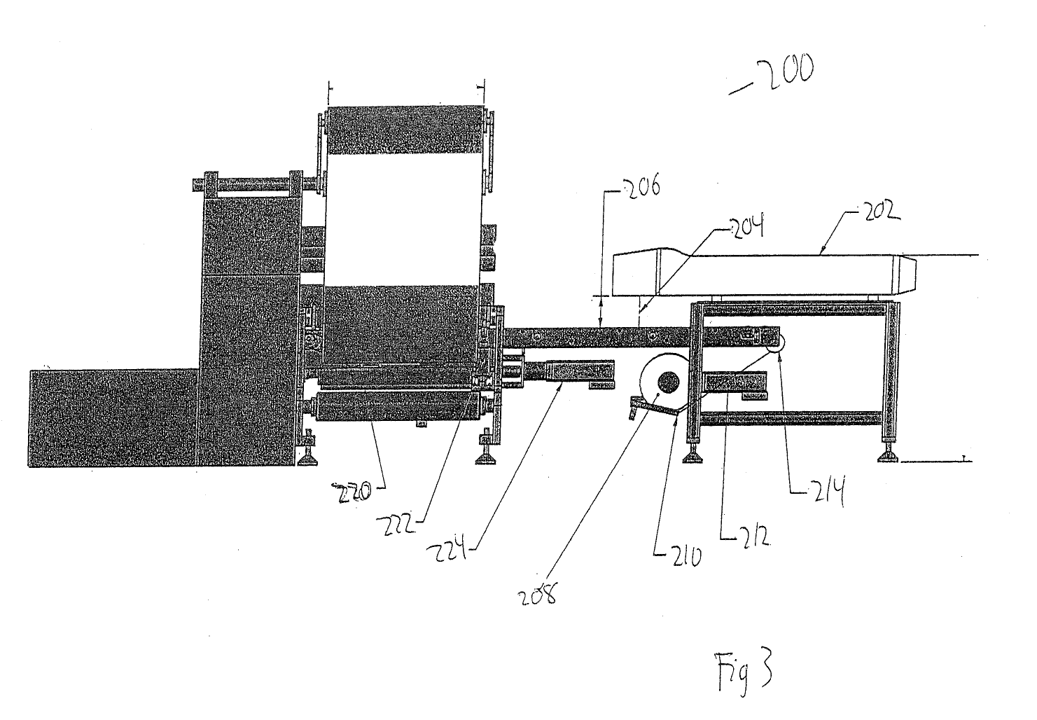

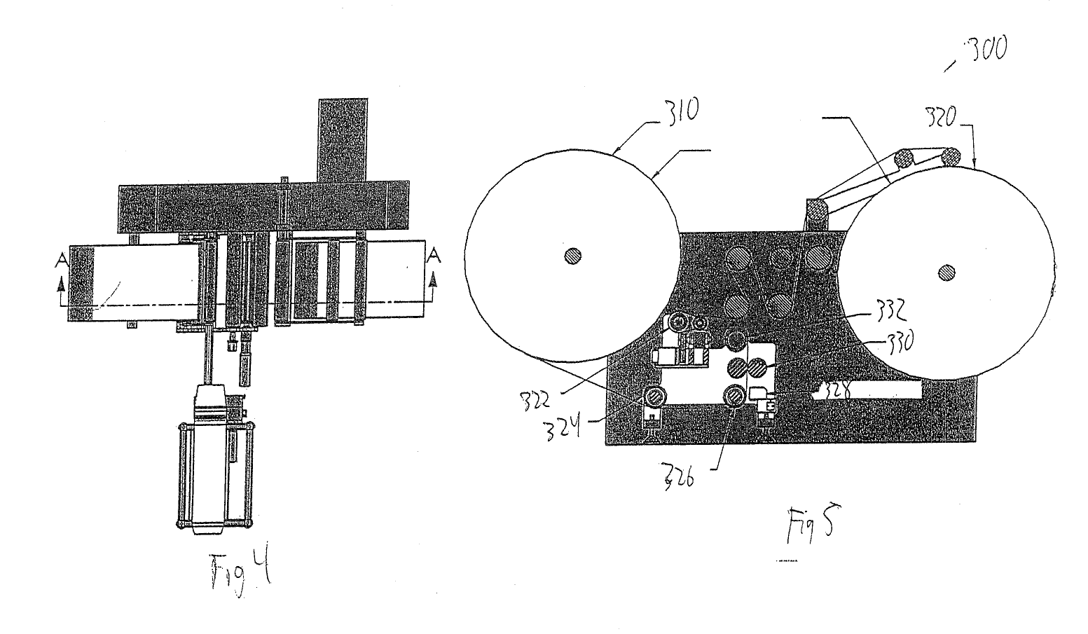

FIG. 3 illustrates a system 200 which comprises a laser 202 with a laser beam 204 and a beam focal length 206. The system further comprises a tear tape roll 208, rider roll 210, tear tape roll servo drive 212 and v-guide roller 214. The system also comprises a vacuum belt servo drive 220, tamp roller air cylinder 222 and a cross perf servo drive 224.

FIG. 5 illustrates a cross-section of system 300 which comprises unwind 310 and rewind 320. The system further comprises tamp roller assembly 322, idler rolls 324 and 326, a registration eye 328, rotary cross-perf 330 and roller roll with encoder 332.

In a preferred embodiment, the strip of tear tape is between about 1/32 and ½ inch in width. The tear tape can be attached to the ream wrap or other packaging material through one of three methods:

(1) The tear tape is treated with self-adhesive material on one side and, when the web is stopped, a bar or other apparatus is used to push the web into the tear tape. The tear tape adheres to the web and at the same time a cutting plate or knife cuts the tear tape to match the width of the web.

(2) The tear tape, which has been treated or coated with wax, is pushed into the web and cut to match the width of the web. Either through the application of pressure or slight thermal energy, the wax enables the tear tape to adhere to the web.

(3) The tear tape, which is comprised of polymer film or paper/polymer film combination is subjected to heat or thermal energy, which makes the polymer tacky, allowing the tear tape to adhere to the ream wrap or other packaging material at the moment of cutting and when pressure is applied to contact the web and the tear tape.

The tear tape is pulled out of a spindle unit above or below the web and is connected to a motor that drives a belt across the web at the moment the web is stopped. While the tear tape applicator is intended to apply 1 to 10 strips at a time while the web is momentarily stopped, the distances at which the strips are applied are adjustable in relationship to the first cutting/application point. The distances may vary depending on the size of the ream wrap or other packaging material, the specific print or graphic repeat pattern of the wrap, and other specific packaging needs. The applicator unit pulls one repeat at a time, cuts and applies the tear tape and then pulls in another repeat. A number of festoon or dancer rolls moves up and down to enable the web, which is winding and unwinding at a constant speed on the rewinder, to momentarily stop as the tear tape is cut and applied. The applicator may be applied in front of a nip that pulls the web into the cutter unit which cuts the tear tape at the moment it is applied to the web. The applicator unit need not run at all times during which the rewinder itself is operated. Rather, the web may be woven straight through the rewinder, avoiding the festoon or dancer rolls used to momentarily pull and stop the web during tear tape application. The applicator unit may be positioned on either the top or underside of the web so that tear tape may be applied on either side of the web.

In another embodiment, a tear tape applicator unit that is separate and removable performs the identical functions described above. However, the applicator may be applied to, fitted for, and removable from the rewinding and/or packaging lines in the paper manufacturer's or other customer's facilities.

In both of these embodiments, the tear tape applicator unit may apply tear tape to the top or underside of the web.

The tear tape is inserted in the ream wrap across the web and can be applied to any type of ream wrap or other packaging material, including paper, film, paper/film combination, or shrink wrap.

In one embodiment, the tear tape comprises a strip of paper or film that is drawn through or coated with wax. The wax is used to adhere the tear tape to the ream wrap or other packaging material. The tear tape is 1/32″ to 1½″ in width and is torn lengthwise, not across the width of the strip.

In another embodiment, the tear tape comprises a non-coated strip of paper or film that is heat-sealed onto the ream wrap or other packaging material. The tear tape is 1/32″ to 1½″ in width and is torn lengthwise, not across the width of the strip.

In another embodiment, the tear tape comprises a strip of high strength polymer film, such as polyethylene or polypropylene, with adhesive on one side of the strip. The adhesive is used to adhere the strip to the ream wrap or other packaging material. The tear tape is 1/32″ to 1½″ in width and is torn lengthwise, not across the width of the strip.

In another embodiment, the tear tape comprises the identical material from which the ream wrap or other packaging material itself is made. For instance, in the case of shrink wrap ream wrap, the tear tape would be made of a similar film material so that it would shrink in proportion to the ream wrap itself.

We claim:

1. A method of attaching tear tape to ream wrap or other packaging material comprising: pulling a web of ream wrap or other packaging material through a number of festoon or dancer rolls that move up and down;
momentarily stopping said ream wrap or other packaging material while wind-up and unwind roll speeds remain constant; and
cutting and applying a strip of tear tape across said web of ream wrap or other packaging material while said web is momentarily stopped.

2. The method of claim 1 further comprising:
treating said tear tape with a self-adhesive material on one side and, when said web is stopped, pushing said web with a bar or other apparatus into said tear tape; and
adhering said tear tape to said web, and at the same time cutting said tear tape to match the width of said web.

3. The method of claim 1 further comprising:
coating said tear tape with wax;
cutting said tear tape to match the width of said web; and
pushing said web in contact with said tear tape.

4. The method of claim 3 further comprising adhering said tear tape to the web by either application of pressure or slight thermal energy.

5. The method of claim 1 further comprising:
applying heat to said tear tape, which is comprised of polymer film or a paper/polymer film combination;
making said polymer tacky; and
adhering said tear tape to said ream wrap or other packaging material at the moment of cutting and when pressure is applied to contact said web and said tear tape.

6. The method of claim 1 further comprising pulling said tear tape out of a spindle unit above or below said web, which is connected to a motor that drives a belt across said web at the moment said web is stopped.

7. The method of claim 1 further comprising applying more than one tear tape in one application.
